(19) United States
(12) Patent Application Publication
(10) Pub. No.: US 2013/0122220 A1
(43) Pub. Date: May 16, 2013

(54) GRAPHENE MANUFACTURING APPARATUS AND METHOD

(71) Applicants: Dong-Kwan Won, Changwon-city (KR); Seung-Min Cho, Changwon-city (KR)

(72) Inventors: Dong-Kwan Won, Changwon-city (KR); Seung-Min Cho, Changwon-city (KR)

(73) Assignee: SAMSUNG TECHWIN CO., LTD., Changwon-city (KR)

(21) Appl. No.: 13/807,360

(22) PCT Filed: Jun. 22, 2011
(86) PCT No.: PCT/KR11/04524

§ 371 Date: Jan. 28, 2013

(30) Foreign Application Priority Data
Jun. 28, 2010 (KR) 10-2010-0061274
Mar. 24, 2011 (KR) 10-2011-0026455

(51) Int. Cl. C01B 31/04

(52) U.S. Cl. CPC C01B 31/0453
USPC 427/595; 118/724; 118/718; 427/249.1

(57) ABSTRACT

A graphene manufacturing apparatus includes a gas supplying unit supplying a gas including carbon; a gas heating unit heating the gas supplied from the gas supplying unit; a deposition chamber in which a substrate having a catalyst layer is disposed; and an inlet pipe introducing the gas of the gas heating unit into the deposition chamber. A temperature of the deposition chamber is set at a temperature lower than a temperature of the gas heating unit so that a selection range with respect to a catalyst metal to be used in the catalyst layer may be expanded, and damage of the substrate due to a high temperature heat may be minimized.

### CROSS-REFERENCE TO RELATED PATENT APPLICATION

This application claims the benefit of Korean Patent Application Nos. 10-2010-0061274, filed on Jun. 28, 2010, and 10-2011-0026455, filed on Mar. 24, 2011 in the Korean Intellectual Property Office, the disclosures of which are incorporated herein their entirety by reference.

### BACKGROUND OF THE INVENTION

1. Field of the Invention

The present invention relates to a graphene manufacturing apparatus and method of manufacturing graphene, and more particularly, to a graphene manufacturing apparatus and method of manufacturing graphene, whereby a large-size stable graphene can be economically manufactured.

2. Description of the Related Art

In general, graphite has a stacked structure of two-dimensional graphene sheets having a plate shape and formed by connecting carbon atoms in a hexagon. Recently, the properties of a graphite layer or a graphene sheet peeled off from among a plurality of graphene layers has been studied. As a result, it has been found that the graphene sheet has very useful properties highly different from those of existing materials.

The most notable property is that, when electrons move in the graphene sheet, the electrons flow as if they have no weight. This means that the electrons flow in the graphene sheet at the speed at which light travels in vacuum, i.e., the speed of light. Also, it has been found that the graphene sheet has an abnormal half-integer quantum hall effect with respect to electrons and holes.

It is known that the electron mobility of the graphene sheet has a high value between about 20,000 and about 50,000 cm²/Vs. Most of all, in the case of carbon nanotubes that are similar to the graphene sheet, the manufacturing yield of carbon nanotubes significantly decreases when the carbon nanotubes are synthesized and refined, so that, although the carbon nanotubes are synthesized by using an inexpensive material, the cost of a complete product is expensive whereas the cost of graphite is low.

In the case of single-walled carbon nanotubes, the metallic and semiconductor properties vary according to their chiral properties and diameters, and although they have the same semiconductor properties, their bandgaps could be different. Thus, in order to take advantage of a specific semiconductor property or metallic property of the single-walled carbon nanotubes, it is necessary to separate the single-walled carbon nanotubes, which is known to be a very difficult process.

On the other hand, since an electrical property of the graphene sheet varies according to the crystalline directionality of the graphene sheet having a predetermined thickness, the electrical property may be realized in a user-selected direction, so that it is easy to design a device. Thus, the features of the graphene sheet may be effectively used in a carbon-based electric device or a carbon-based electromagnetic device.

As described above, the graphene sheet has very useful characteristics but it is difficult to repeatedly manufacture a large-size graphene sheet in an economical manner. Methods of manufacturing a graphene sheet are classified into two types, i.e., a micro-mechanical method and a SiC crystal pyrolyzing method.

The micro-mechanical method involves adhering a Scotch tape to a graphite sample, peeling off the Scotch tape, and obtaining a graphene sheet on a surface of the Scotch tape which is peeled off from the graphite sample. In this case, the peeled-off graphene sheet has an irregular number of layers and various shapes. Thus, it is impossible to obtain a large-size graphene sheet by using the micro-mechanical method.

In the SiC crystal pyrolyzing method, after a SiC single crystal is heated, SiC on the surface of the single crystal is analyzed and Si is removed, and then a graphene sheet is formed by the remaining carbon C. However, in this method, the SiC single crystal used as a starting material is very expensive, and it is highly difficult to obtain a large-size graphene sheet by using the SiC crystal pyrolyzing method.

### SUMMARY OF THE INVENTION

The present invention provides a graphene manufacturing apparatus and method of manufacturing graphene in order to economically manufacture a large-size stable graphene.

According to an aspect of the present invention, there is provided a graphene manufacturing apparatus including a gas supplying unit supplying a gas comprising carbon; a gas heating unit heating the gas supplied from the gas supplying unit; a deposition chamber in which a substrate having a catalyst layer is disposed; and an inlet pipe for supplying the gas of the gas heating unit into the deposition chamber.

The gas heating unit may include a gas chamber having a sealed space where the gas is heated; and a gas heater disposed in the gas chamber so as to apply heat to the gas.

The gas heater may be a lamp that radiates heat.

The gas heating unit may further include a quartz pipe disposed in the gas chamber so as to be adjacent to the gas heater, and a gas to be heated by the gas heater is supplied to the quartz pipe.

An end of the quartz pipe may pass through the gas chamber and may be connected to the gas supplying unit, and another end of the quartz pipe may pass through the gas chamber and may be connected to the inlet pipe.

The gas chamber may include a graphite material coated with pyrolitic boron nitride (PBN).

The graphene manufacturing apparatus may further include a substrate heating unit disposed in the deposition chamber and applying heat to the substrate.

The substrate heating unit may heat the deposition chamber at a temperature lower than a heating temperature of the gas heating unit.

The substrate heating unit may be a lamp that radiates heat.

The inlet pipe may include an insulating unit surrounding at least one portion of the inlet pipe.

The graphene manufacturing apparatus may further include a pipe heating unit that heats the inlet pipe.

The graphene manufacturing apparatus may further include a substrate supplying unit including a first roller that supports a part of the substrate, and a second roller that supports the other part of the substrate, and continuously supplying the substrate so as to allow the substrate to pass through an inlet and an outlet of the deposition chamber.

The graphene manufacturing apparatus may further include covers movably disposed in the deposition chamber so as to open and close the inlet and the outlet.

According to another aspect of the present invention, there is provided a method of manufacturing graphene, the method including the operations of moving a substrate having a catalyst layer to a deposition chamber; supplying a gas comprising carbon to a gas chamber separately disposed from the deposition chamber; heating the gas in the gas chamber; and introducing the gas heated in the gas chamber into the deposition chamber, and synthesizing graphene on the substrate.

The operation of heating the gas may include the operation of heating the gas by radiating heat from a lamp disposed in the gas chamber.

The operation of supplying the gas may include the operation of supplying an atmosphere gas together with a reaction gas comprising carbon.

The operation of synthesizing the graphene may include the operations of dividing the reaction gas including carbon and the atmosphere gas, and then introducing only the reaction gas into the deposition chamber.

The operation of synthesizing the graphene may include the operation of heating the substrate introduced into the deposition chamber.

The operation of heating the substrate may include the operation of heating the substrate by radiating heat from a lamp disposed in the deposition chamber.

The operation of heating the substrate may include the operation of heating the substrate at a temperature lower than a temperature for heating the gas in the heating of the gas.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram illustrating a graphene manufacturing apparatus according to an embodiment of the present invention;

FIG. 2 is a cross-sectional view of a substrate used in the graphene manufacturing apparatus of FIG. 1;

FIG. 3 is a cross-sectional view illustrating graphene synthesized on the substrate of FIG. 2;

FIG. 4 is a flowchart of a method of manufacturing graphene, according to an embodiment of the present invention; and

FIG. 5 is a diagram illustrating a graphene manufacturing apparatus according to another embodiment of the present invention.

### DETAILED DESCRIPTION OF THE INVENTION

Hereinafter, the present invention will be described in detail by explaining exemplary embodiments of the invention with reference to the attached drawings.

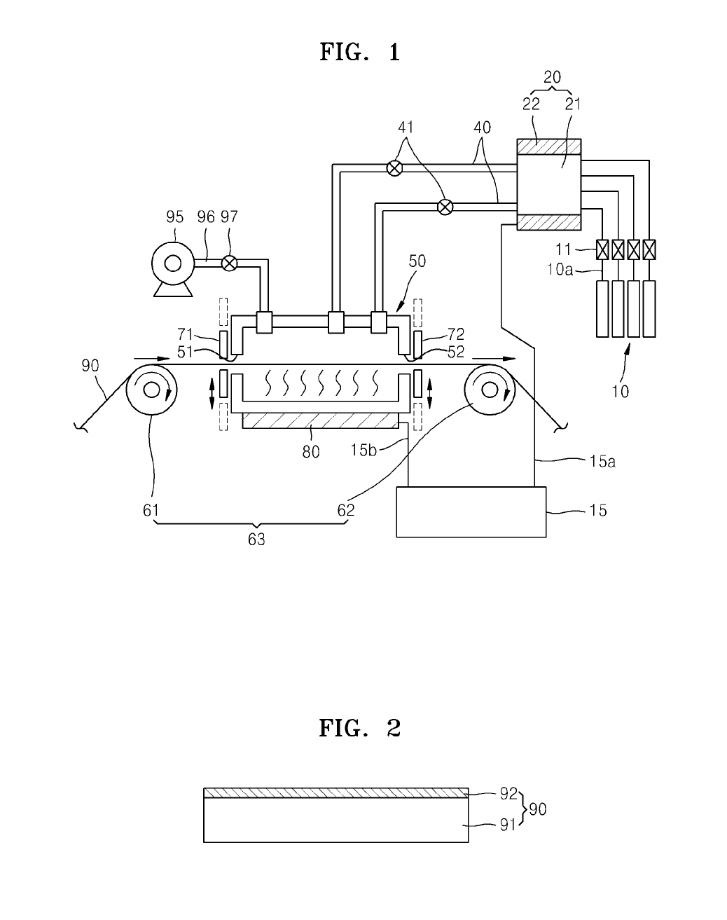

FIG. 1 is a block diagram illustrating a graphene manufacturing apparatus according to an embodiment of the present invention.

The graphene manufacturing apparatus of FIG. 1 includes a gas supplying unit 10 supplying a gas including carbon, a gas heating unit 20 heating the gas supplied from the gas supplying unit 10, a deposition chamber 50 in which a substrate 90 having a catalyst layer is disposed, and an inlet pipe 40 introducing a gas, which is heated and analyzed by the gas heating unit 20, to the deposition chamber 50.

In the graphene manufacturing apparatus, the gas heating unit 20 for heating the gas and the deposition chamber 50 for depositing graphene on a surface of the substrate 90 are separated. Accordingly, it is possible to reduce an effect on the deposition chamber 50 which is incurred due to a heating process performed in the gas heating unit 20 so as to analyze the gas including carbon. That is, a temperature for heating the substrate 90 in the deposition chamber 50 is less than a temperature for heating the gas in the gas heating unit 20, so that a damage of the substrate 90 may be prevented although the gas is heated at a high temperature so as to be analyzed.

The gas supplying unit 10 supplies a reaction gas (a source gas) that is a gas including carbon to the gas heating unit 20. The reaction gas supplied by the gas supplying unit 10 is a compound including carbon, and the compound may include6 or less carbon atoms, 4 or less carbon atoms, or 2 or less carbon atoms. The reaction gas may include at least one selected from the group consisting of carbon monoxide, carbon dioxide, ethane, ethylene, ethanol, acetylene, propane, propylene, butane, butadiene, pentane, pentene, cyclopentadien, hexane, cyclohexane, benzene, and toluene.

The gas supplying unit 10 may supply an atmosphere gas together with the reaction gas. The atmosphere gas may include an inert gas such as helium, argon, or the like, and a non-reaction gas including hydrogen for controlling a gas phase reaction by cleanly maintaining a surface of a metal catalyst clean.

A control valve 11 may be installed in a supply tube 10a connecting the gas supplying unit 10 and a gas chamber 21, so that the control valve 11 may control a flow of a gas supplied from the gas supplying unit 10 to the gas chamber 21.

The term “graphene” or “graphene sheet” used in the detailed description indicates sheet-shape graphene in which a plurality of carbon atoms are connected via a covalent bond and then form polycyclic aromatic molecules. The carbon atoms connected via the covalent bond basically form a six-membered ring but may further include a five-membered ring and/or a seven-membered ring. Thus, the graphene sheet is formed as a single layer of the carbon atoms connected via the covalent bond (generally, a sp2 bond). However, the graphene sheet may have various structures that may vary according to content of the five-membered ring and/or the seven-membered ring which may be included in the graphene.

As described above, the graphene sheet may be formed as a single layer of graphene, however, it is also possible to form the graphene sheet as a multi-layer by stacking a plurality of graphene layers to have a thickness corresponding to maximum 300 layers. In general, a side end portion of the graphene is saturated with hydrogen atoms.

The gas heating unit 20 includes the gas chamber 21 containing a gas supplied from the gas supplying unit 10, and a gas heater 22 arranged in the gas chamber 21 so as to heat the gas chamber 21.

The deposition chamber 50 is manufactured by using quartz or a metal material such as stainless steel, and is a place where graphene is synthesized on the surface of the substrate 90. The deposition chamber 50 is formed separate from the gas chamber 21 of the gas heating unit 20, and is connected to the gas chamber 21 via the inlet pipe 40. A gas supply valve 41 is arranged in the introduction pipe 40 so as to control a supply of a heated gas from the gas chamber 21 to the deposition chamber 50.

The deposition chamber 50 has an inlet 51 through which the substrate 90 is supplied, and an outlet 52 from which the substrate 90 is discharged. Also, in order to open and close the inlet 51 and the outlet 52, covers 71 and 72 moving in an arrow direction are disposed in the deposition chamber 50. When a process of synthesizing graphene on the surface of the substrate 90 is performed, a gas heated in the gas chamber 21 is supplied to the deposition chamber 50 and simultaneously the deposition chamber 50 is heated, and thus, the covers 71 and 72 close the inlet 51 and the outlet 52 so as to separate an atmosphere of the deposition chamber 50 from the outside. After the process of synthesizing graphene is completed, the covers 71 and 72 operate to open the inlet 51 and the outlet 52 so that the substrate 90 may move while passing through the deposition chamber 50.

A substrate heating unit 80 may be arranged in the deposition chamber 50 so as to heat the deposition chamber 50. The substrate heating unit 80 and the gas heater 22 may be connected to a control unit 15 via wires 15a and 15b and may be controlled by the control unit 15.

An exhausting pump 95 is connected to the deposition chamber 50 so as to externally exhaust a gas from the deposition chamber 50 via an exhausting pipe 96. An exhausting valve 97 is arranged in the exhausting pipe 96 so as to control exhaustion of the gas. After the graphene sheet is completely formed in the deposition chamber 50, the exhausting valve 97 operates to externally exhaust the gas in the deposition chamber 50.

For synthesis of the graphene sheet, the substrate heating unit 80 functions to control a temperature in the deposition chamber 50. Thus, unlike the gas heater 22 that heats the gas chamber 21 at a high temperature for analyzing the reaction gas including carbon, the substrate heating unit 80 may heat the deposition chamber 50 at a low temperature.

When the gas heated in the gas chamber 21 is supplied to the deposition chamber 50, the atmosphere gas may be removed and then only a component containing carbon that is decomposed from the reaction gas may be filtered and supplied. Alternatively, the reaction gas together with the atmosphere gas may be supplied to the deposition chamber 50.

The gas heater 22 may heat the gas chamber 21 at a temperature in the range of about 300° C. to about 2000° C. The substrate heating unit 80 may heat the deposition chamber 50 in the range of about 300° C. to about 1,000° C.

After the reaction gas including carbon is supplied to the deposition chamber 50, if the reaction gas is analyzed and simultaneously the deposition chamber 50 is heated at a temperature equal to or greater than about 1000° C. so as to synthesize graphene on the substrate 90, a catalyst metal to be deposited on the surface of the substrate 90 is limited to a material having high heat resistance. Also, when the deposition chamber 50 is heated at a temperature equal to or greater than about 1000° C., the substrate 90 may be thermally damaged.

However, in the graphene manufacturing apparatus of FIG. 1, the deposition chamber 50 and the gas chamber 21 are separate from each other and then are heated at different temperatures, so that the reaction gas including carbon may be efficiently analyzed, and simultaneously, graphene may be stably synthesized on the surface of the substrate 90.

Heat sources to drive the gas heater 22 and the substrate heating unit 80 may include induction heating, radiant heat, a laser, IR, a microwave, plasma, ultraviolet (UV), surface plasmon heating, or the like. The heat sources may be attached to the gas chamber 21 or the deposition chamber 50 and may function to increase a temperature in the gas chamber 21 or the deposition chamber 50 to a predetermined temperature.

The substrate 90 whereon graphene is synthesized may be continuously supplied to the deposition chamber 50 by a substrate supplying unit 63. In the graphene manufacturing apparatus of FIG. 1, a roll-to-roll method is used.

The substrate supplying unit 63 includes a first roller 61 that rolls and supports a part of the substrate 90, and a second roller 62 that rolls and supports the other part of the substrate 90. Although not illustrated in FIG. 1, the first roller 61 and the second roller 62 may be rotated by a motor, a belt, or a chain. The substrate 90 is continuously supplied to the deposition chamber 50 by the substrate supplying unit 63 so as to pass through the inlet 51 and the outlet 52.

One or more embodiments of the present invention are not limited to the aforementioned manner of supplying the substrate 90, and thus various equipment such a conveyor belt, a transporting robot, or the like may be used.

FIG. 2 is a cross-sectional view of the substrate 90 used in the graphene manufacturing apparatus of FIG. 1.

The substrate 90 that is supplied to the deposition chamber 50 includes a base layer 91 and a catalyst layer 92 disposed on a surface of the base layer 91.

The base layer 91 may be formed of a material that is heat-resistant and has high adhesion to graphene. Alternatively, the base layer 91 itself may have such a characteristic or a material having such a characteristic may be coated on the base layer 91. The material for the base layer 91 may be an inorganic substrate including a Si substrate, a glass substrate, a GaN substrate, a silica substrate or the like, or may be a metal substrate including Ni, Cu, W, or the like. Examples of the material used in the base layer 91 may include SiO₂, Si₃N₄, SiON, SIOF, BN, hydrogen silsesquiloxane (HSQ), xerogel, aero gel, poly naphthalene, amorphous carbon a-CF, SiOC, MSQ, black diamond, or the like.

The catalyst layer 92 disposed on the surface of the base layer 91 functions as a graphite catalyst and helps carbon components to combine with each other so as to form a hexagonal plate-shape structure, wherein the carbon components are included in the heated gas that is supplied from the gas chamber 21 to the deposition chamber 50. The catalyst layer 92 may include one catalyst used to synthesize graphene, to induce carbonation reaction, or to manufacture carbon nanotubes.

The catalyst layer 92 may include at least one metal catalyst selected from the group consisting of nickel (Ni), cobalt (Co), ferrum (Fe), platinum (Pt), gold (Au), silver (Ag), aluminium (Al), chrome (Cr), copper (Cu), magnesium (Mg), manganese (Mn), molybdenum (Mo), rhodium (Rh), silicon (Si), tantalum (Ta), titanium (Ti), tungsten (W), uranium (U), vanadium (V), palladium (Pd), yttrium (Y), and zirconium (Zr). The catalyst layer 92 may be formed by depositing a metal catalyst on the base layer 91 by using a sputtering device, an e-beam evaporator, or the like.

The catalyst layer 92 may be formed in another manner. For example, the catalyst layer 92 may be directly prepared in the form of a metal thin film (e.g., a foil). In this case, the base layer 91 formed of a silicon wafer material and including a SiO₂ layer may not be used.

Although not illustrated in FIG. 2, a block layer may be previously coated on the surface of the base layer 91 so as to restrain an unnecessary reaction between the catalyst layer 92 and the base layer 91. The block layer exists between the catalyst layer 92 and the base layer 91 so that the block layer may restrain a graphene forming efficiency from being decreased due to a reaction between the catalyst layer 92 and the base layer 91. The block layer may include SiOx, TiN, Al₂O₃, TiO₂, Si3N4, or the like, and may be formed on the base layer 91 by using a sputtering method or the like.

In order to increase the adhesion between the substrate 90 and graphene and to promote growth of the graphene in a planar direction while generation of CNT is restrained, an activation process may be performed on the surface of the substrate 90.

By using the graphene manufacturing apparatus of FIG. 1, the substrate 90 having the catalyst layer 92 functioning as a graphite catalyst is supplied to the deposition chamber 50, a gas (a gas-phase carbon supply source) including carbon supplied from the gas chamber 21 is supplied to the deposition chamber 50 and simultaneously the deposition chamber 50 is heated, graphene is formed on the surface of the substrate 90, and then the graphene is cooled and grown, so that a graphene sheet is formed on the surface of the substrate 90.

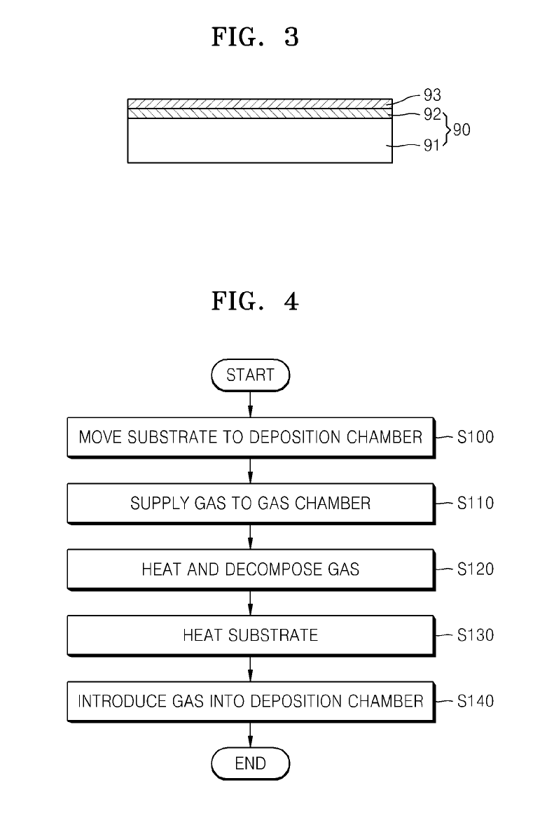

FIG. 3 is a cross-sectional view illustrating graphene synthesized on the substrate 90 of FIG. 2.

When a heated gas supplied from the gas chamber 21 is supplied to the deposition chamber 50 with a predetermined pressure and is thermally heated for a predetermined time period at a predetermined temperature, carbon components existing in a gas-phase carbon supply source form a hexagonal plate-shape structure by combining with each other, so that graphene is formed. By cooling the graphene at a predetermined cooling speed, it is possible to obtain a graphene sheet 93 having a uniform array status.

In a cooling process, the graphene sheet 93 is grown by separating carbon from the catalyst layer 92 and crystallizing the carbon by rapidly cooling the graphene sheet 93 at a cooling speed in the range of about 30° C./min to about 600° C./min. The cooling process may be performed by cooling the deposition chamber 50, or may be performed in a separate place by moving the substrate 90 whereon graphene is formed outside the deposition chamber 50.

FIG. 4 is a flowchart of a method of manufacturing graphene, according to an embodiment of the present invention.

The method of manufacturing graphene in FIG. 4 involves moving a substrate having a catalyst layer to a deposition chamber (operation S100), supplying a gas including carbon to a gas chamber separately disposed from the deposition chamber (operation S110), analyzing the gas by heating the gas in the gas chamber (operation S120), introducing the gas analyzed in the gas chamber into the deposition chamber and then synthesizing graphene on the substrate (operations S130 and S140).

In operation S110, a reaction gas including carbon is supplied. The reaction gas may use at least one selected from the group consisting of carbon monoxide, carbon dioxide, ethane, ethylene, ethanol, acetylene, propane, propylene, butane, butadiene, pentane, pentene, cyclopentadien, hexane, cyclohexane, benzene, and toluene.

In operation S110, an atmosphere gas may be supplied together with the reaction gas. The atmosphere gas may include an inert gas such as helium, argon, or the like, and a non-reaction gas including hydrogen for controlling a gas phase reaction by cleanly maintaining a surface of a metal catalyst clean.

In operation S130, the substrate is heated, and in operation S140, the gas that is heated and analyzed in the gas chamber is introduced into the deposition chamber. Operation S140 may be performed before operation 130, or operations S130 and S140 may be simultaneously performed.

In operation 140 of heating and analyzing the gas, the gas chamber may be heated in the range of about 300° C. to about 2000° C. In operation S130, the substrate may be heated in the range of about 300° C. to about 1,000° C.

After the reaction gas including carbon is supplied to the deposition chamber, if the reaction gas is analyzed and simultaneously the deposition chamber is heated at a temperature equal to or greater than about 1000° C. so as to synthesize graphene on the substrate, the substrate may be thermally damaged.

However, according to the method of manufacturing graphene in FIG. 4, the deposition chamber and the gas chamber are separate from each other and are heated in different temperature ranges, so that the reaction gas including carbon may be efficiently analyzed, and simultaneously, graphene may be stably synthesized on a surface of the substrate.

After graphene is formed on the surface of the substrate by introducing the gas into the deposition chamber, an operation of cooling the substrate may be performed so as to grow graphene on the surface of the substrate by cooling the substrate.

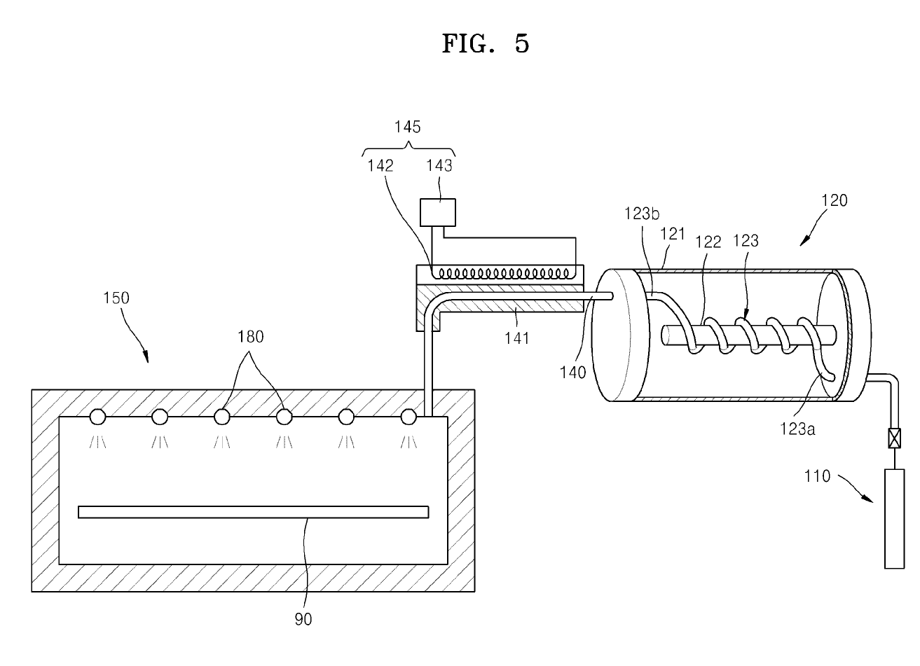

FIG. 5 is a diagram illustrating a relation between configuring elements of a graphene manufacturing apparatus according to another embodiment of the present invention.

The graphene manufacturing apparatus of FIG. 5 includes a gas supplying unit 110 supplying a gas including carbon, a gas heating unit 120 heating the gas supplied from the gas supplying unit 110, a deposition chamber 150 in which a substrate 90 having a catalyst layer is disposed, and an inlet pipe 140 for introducing a gas which is heated and analyzed by the gas heating unit 120 to the deposition chamber 150.

Similar to the previous embodiment of FIGS. 1 through 3, in the graphene manufacturing apparatus of FIG. 5, the gas heating unit 120 in which the gas is heated is separate from the deposition chamber 150 so that it is possible to reduce an effect on the deposition chamber 150 due to a heating process performed so as to analyze the gas including carbon.

The gas heating unit 120 includes a gas chamber 121 forming a sealed space for heating the gas, and a gas heater 122 disposed in the gas chamber 121 so as to apply heat to the gas.

A quartz pipe 123 functioning as a passage for a gas to be heated may be disposed in the gas chamber 121. An end 123a of the quartz pipe 123 passes through the gas chamber 121 and then is connected to the gas supplying unit 110, so that a gas supplied from the gas supplying unit 110 may enter the gas chamber 121.

The other end 123b of the quartz pipe 123 passes through the gas chamber 121 and then is connected to the inlet pipe 140, so that a gas heated in the gas chamber 121 may be supplied to the deposition chamber 150 via the inlet pipe 140.

The gas heater 122 may be a lamp that radiates heat. For example, the gas heater 122 may include a plurality of halogen lamps. The heat radiated from the gas heater 122 may rapidly heat the gas in the quartz pipe 123 up to a process temperature.

The gas heating unit 120 having the aforementioned structure functions as a rapid thermal processing (RTP) apparatus. The RTP apparatus may achieve a desired effect in a high temperature condition and may perform a thermal treatment process for a short time period (in general, for several seconds to several minutes), so that the RTP apparatus may minimize impurities that are is unnecessarily diffused or oxides that are unnecessarily generated.

For example, the gas chamber 121 may include a graphite material coated with pyrolitic boron nitride (PBN).

The inlet pipe 140 is connected to each of the deposition chamber 150 and the gas chamber 121, and supplies the heated gas of the gas chamber 121 to the deposition chamber 150. In order to increase an insulation effect, a length of the inlet pipe 140 may be minimized. Also, the inlet pipe 140 includes an insulating unit 141 surrounding a portion of the inlet pipe 140.

In order to prevent a temperature decrease in the inlet pipe 140, a pipe heating unit 145 is disposed outside the inlet pipe 140 to heat the inlet pipe 140. The pipe heating unit 145 includes a heater 142 heating the inlet pipe 140, and a power unit 143 supplying current to the heater 142.

A substrate heating unit 180 is disposed in the deposition chamber 150. Similar to the gas heating unit 120, the substrate heating unit 180 may be an RTP apparatus. That is, the substrate heating unit 180 may be a lamp that radiates heat, and thus may rapidly heat the substrate 90 by radiation heat.

The RTP apparatus may freely control a heating time and a cooling time, so that, by making the substrate heating unit 180 and the gas heating unit 120 separate from each other, it is possible to reduce a time taken to synthesize graphene. That is, a process temperature of the gas heating unit 120 may be set to be high so as to rapidly heat the gas, and the substrate heating unit 180 may heat the substrate 90 at a process temperature lower than the process temperature of the gas heating unit 120.

Also, by differently setting the process temperature for each of the substrate heating unit 180 and the gas heating unit 120, a time and energy for heating the substrate 90, and a time and energy for heating the gas may be optimized according, so that energy consumption may be reduced.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A graphene manufacturing apparatus comprising:
a gas supplying unit supplying a gas comprising carbon;
a gas heating unit heating the gas supplied from the gas supplying unit;
a deposition chamber in which a substrate having a catalyst layer is disposed; and
an inlet pipe for supplying the gas of the gas heating unit into the deposition chamber.

2. The graphene manufacturing apparatus of claim 1, wherein the gas heating unit comprises:
a gas chamber having a sealed space where the gas is heated; and
a gas heater disposed in the gas chamber so as to apply heat to the gas.

3. The graphene manufacturing apparatus of claim 2, wherein the gas heater is a lamp that radiates heat.

4. The graphene manufacturing apparatus of claim 3, wherein the gas heating unit further comprises a quartz pipe disposed in the gas chamber so as to be adjacent to the gas heater, and a gas to be heated by the gas heater is supplied to the quartz pipe.

5. The graphene manufacturing apparatus of claim 4, wherein an end of the quartz pipe passes through the gas chamber and is connected to the gas supplying unit, and another end of the quartz pipe passes through the gas chamber and is connected to the inlet pipe.

6. The graphene manufacturing apparatus of claim 2, wherein the gas chamber comprises a graphite material coated with pyrolitic boron nitride (PBN).

7. The graphene manufacturing apparatus of claim 1, further comprising a substrate heating unit disposed in the deposition chamber and applying heat to the substrate.

8. The graphene manufacturing apparatus of claim 7, wherein the substrate heating unit heats the deposition chamber at a temperature lower than a heating temperature of the gas heating unit.

9. The graphene manufacturing apparatus of claim 7, wherein the substrate heating unit is a lamp that radiates heat.

10. The graphene manufacturing apparatus of claim 1, wherein the inlet pipe comprises an insulating unit surrounding at least one portion of the inlet pipe.

11. The graphene manufacturing apparatus of claim 10, further comprising a pipe heating unit that heats the inlet pipe.

12. The graphene manufacturing apparatus of claim 1, further comprising a substrate supplying unit comprising a first roller that supports a part of the substrate, and a second roller that supports the other part of the substrate, and continuously supplying the substrate so as to allow the substrate to pass through an inlet and an outlet of the deposition chamber.

13. The graphene manufacturing apparatus of claim 12, further comprising covers movably disposed in the deposition chamber so as to open and close the inlet and the outlet.

14. A method of manufacturing graphene, the method comprising:
moving a substrate having a catalyst layer to a deposition chamber;
supplying a gas comprising carbon to a gas chamber separately disposed from the deposition chamber;
heating the gas in the gas chamber; and
introducing the gas heated in the gas chamber into the deposition chamber, and synthesizing graphene on the substrate.

15. The method of claim 14, wherein the heating of the gas comprises heating the gas by radiating heat from a lamp disposed in the gas chamber.

16. The method of claim 14, wherein the supplying of the gas comprises supplying an atmosphere gas together with a reaction gas comprising carbon.

17. The method of claim 14, wherein the synthesizing of the graphene comprises dividing the reaction gas comprising carbon and the atmosphere gas, and then introducing only the reaction gas into the deposition chamber.

18. The method of claim 14, wherein the synthesizing of the graphene comprises heating the substrate introduced into the deposition chamber.

19. The method of claim 18, wherein the heating of the substrate comprises heating the substrate by radiating heat from a lamp disposed in the deposition chamber.

20. The method of claim 19, wherein the heating of the substrate comprises heating the substrate at a temperature lower than a temperature for heating the gas in the heating of the gas.
